(19) United States
(12) Patent Application Publication
(10) Pub. No.: US 2011/0023018 A1
(43) Pub. Date: Jan. 27, 2011

(54) SOFTWARE PLATFORM AND METHOD OF MANAGING APPLICATION INDIVIDUALS IN THE SOFTWARE PLATFORM

(75) Inventors: Soo-Myung PARK, Daejeon (KR); Jea-Hoon YU, Daejeon (KR); Byung-Jun AHN, Daejeon (KR); Tae-Whan YOO, Daejeon (KR)

Correspondence Address: AMPACC Law Group, PLLC, 6100 219th Street SW, Suite 580, Mountlake Terrace, WA, 98043, US

(73) Assignee: Electronics and Telecommunications Research Institute, Daejeon (KR)

(21) Appl. No.: 12/841,019

(22) Filed: Jul. 21, 2010

(30) Foreign Application Priority Data
Jul. 21, 2009 (KR) 10-2009-0066506

(51) Int. Cl. G06F 9/44

(52) U.S. Cl. 717/121; 717/120

(57) ABSTRACT

A component-based system plane software platform is provided and the software platform includes an individual identifier manager to assign an individual identifier to each object of an application that is executed in a distributed computing environment and to manage the individual identifier, and an instance provider to create an instance for a service object in response to a request from the application and to provide the instance to the application. The software platform may systematically and effectively manage and control applications of system software under a component-based system software architecture to which a container model structure is applied.

### CROSS-REFERENCE TO RELATED APPLICATION

This application claims the benefit under 35 U.S.C. §119(a) of a Korean Patent Application No. 10-2009-0066506, filed on Jul. 21, 2009, the entire disclosure of which is incorporated herein by reference for all purposes.

### BACKGROUND

1. Field

The following description relates to a system software platform for a packet-optical transport system, and more particularly, to a component based system plane software platform.

2. Description of the Related Art

A variety of types of transport systems have adopted a component-based system software platform architecture.

A system plane software platform has to provide system plane services, which applications of a management plane and a control plane placed on system software commonly need, in a consistent and integrated environment, and manage the applications on an individual basis. However, management on individual-based services for applications that are provided by a system plane software platform has not been sufficiently developed yet, wherein an individual is defined as an application to be actually executed and a process unit that is identified by the application identifier. The system plane software platform classifies objects into individual applications depending on application deployment of the system software and manages the status of each individual application. Also, the system plane software platform manages the start, re-start and termination operations of applications depending on deployment and manages system resource allocations of the individual applications. If there is no integrated management on the individuals of the system software, the execution and management of the entire system becomes inefficient, which leads to negative influences on services that are provided by the system. For these reasons, a systematical configuration for management of individual applications in a system plane software platform is needed.

### SUMMARY

The following description relates to a software platform architecture where applications on a management plane and a control plane can be effectively operated and managed with the component based system software based on a container model architecture.

In one general aspect, there is provided a software platform including: an individual identifier manager to assign an individual identifier to each object of an application that is executed in a distributed computing environment and to manage the individual identifier; and an instance manager to create an instance for a service object in response to a request from the application and to provide the instance to the application.

The software platform may provide an individual-based Remote Method Invocation (RMI) service, an event service, a Log/Trace service, a database access service, a Life Cycle Service (LCS) and Thread/timer services to the application.

In another general aspect, there is provided a method of managing applications as individuals in a software platform, including: creating an instance for a service object in response to a request from an application that is executed in a distributed computing environment; and providing the instance for the service object to the application.

The method may further includes: creating a list of objects of applications that are executed; creating an individual identifier for each of the applications based on the list of the objects of the applications and physical location data of the applications; and storing the individual identifiers in the form of a list of individual identifiers.

Other features and aspects will be apparent from the following detailed description, the drawings, and the claims.

### BRIEF DESCRIPTION OF THE DRAWINGS

FIG. 1 is a diagram illustrating an example of a software platform.

FIG. 2 is a diagram illustrating an example of a Remote Method Invocation (RMI) service unit.

FIG. 3 is a diagram illustrating an example of an event service unit.

FIG. 4 is a diagram illustrating an example of a Log/Trace service unit.

FIG. 5 is a diagram illustrating an example of a database access service unit.

FIG. 6 is a diagram illustrating an example of a Life Cycle Service (LCS) unit.

FIG. 7 is a diagram illustrating an example of an individual identifier management unit.

FIG. 8 is a diagram illustrating an example of a thread/timer service unit.

FIG. 9 is a diagram illustrating an example of a packet-optical transport system.

FIG. 10 is a flowchart illustrating an example of a method of initializing a server process in a system plane software platform on a system manager.

FIG. 11 is a flowchart illustrating an example of a method of initializing a server process in a system plane software platform on a data transporter.

FIG. 12 is a flowchart illustrating an example of a method of initializing a container environment that is used by an application on a system manager.

FIG. 13 is a flowchart illustrating an example of a method in which applications on a system manager and a data transporter use a naming service.

FIG. 14 is a flowchart illustrating an example of a method in which applications on a system manager and a data transporter use an event service.

FIG. 15 is a flowchart illustrating an example of a method in which applications on a system manager and a data transporter use a log/trace service and a database access service.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

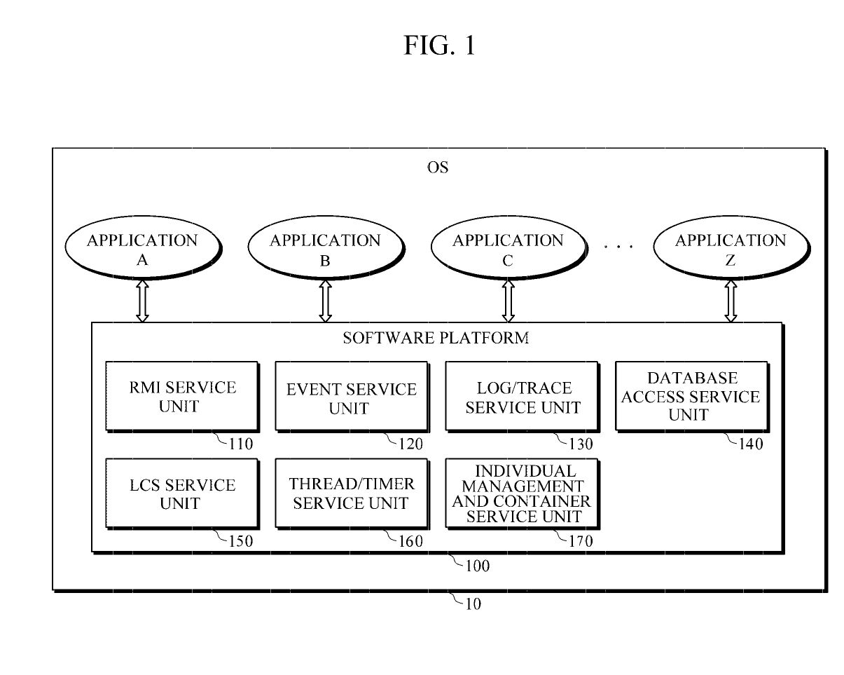

FIG. 1 is a diagram illustrating an example of a software platform 100.

As illustrated in FIG. 1, the software platform 100 is established based on an operating system (OS). Referring to FIG. 1, the software platform 100 includes individual service units, for example, an individual based Remote Method Invocation (RMI) service unit 110, an event service unit 120, a Log/Trace service unit 130, a database access service unit 140, a Life Cycle Service (LCS) unit 150 and a Thread/Timer service unit 160. The service units are managed by an individual management and container service unit 170 included in the software platform 100. The service units provide applications, such as application A, application B, application C, which use services of the software platform 100, with the corresponding services.

When applications are executed in a distributed computing environment, the applications are instantized and exist in the form of objects. In this case, the applications may exist as one or more objects depending on where the applications are executed in the form of objects. The individual management and container service unit 170 assigns individual identifiers to the objects in order to manage the objects as separate individuals depending on deployment of the applications on the software platform 100 that supports the distributed computing environment. The individual management and container service unit 170 may provide services on the software platform 100 only to individuals identified by the individual identifiers.

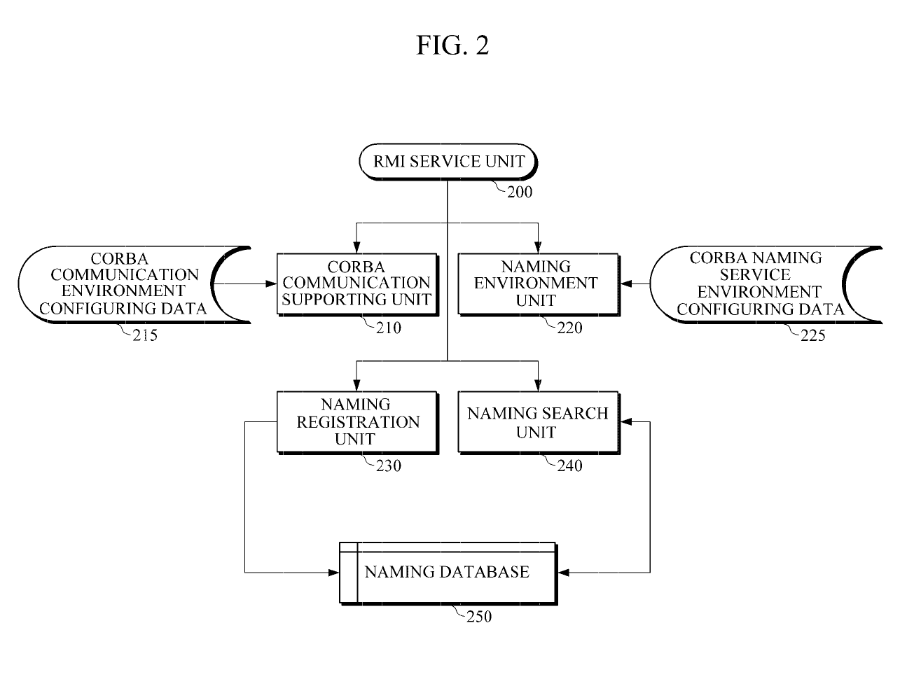

FIG. 2 is a diagram illustrating an example of a Remote Method Invocation (RMI) service unit 200.

As illustrated in FIG. 2, the RMI service unit 200 provides a Common Object Request Broker Architecture (CORBA) based communication unit 210 for providing a CORBA based communication environment with upper applications, a naming environment unit 220 for providing a naming service, a naming registration unit 230 and a naming search unit 240.

The CORBA based communication unit 210 ensures interoperability between objects based on a CORBA standard specification for stable communications. According to an example, the CORBA based communication unit 210 is established using CORBA communication environment configuring data 215 in order to support a distributed computing environment. The CORBA communication environment configuring data 215 includes information regarding the names and IP addresses of physical hosts in which the upper applications are executed.

Each application registers information indicating an access interface of an instantized individual in the form of individual identifier information, which is provided by an individual management and container service, in a naming service server, through the naming registration unit 230. That is, the naming registration unit 230 may register the locations of access interfaces of instantized individuals for all applications on a software platform, in the form of individual identifier information that are provided by an individual management and container service, in a naming service server.

Accordingly, the applications may use individual identifiers provided by the individual management and container service to search for the locations of object-access interfaces of all applications registered in a naming database 250 though the naming search unit 240. As a result, the applications can perform CORBA based communications by searching for the locations of object-access interfaces for objects that attempt to communicate.

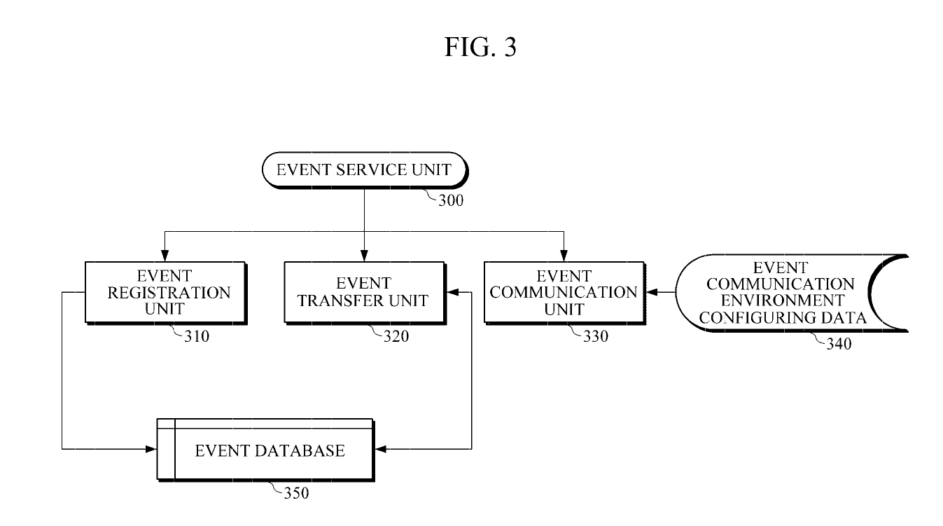

FIG. 3 is a diagram illustrating an example of an event service unit 300.

As illustrated in FIG. 3, the event service unit 300 includes an event registration unit 310, an event transfer unit 320 and an event communication unit 330. A communication environment of the event communication unit 330 is established using event communication environment configuring data 340. The event communication environment configuring data 340 includes information regarding the names, IP addresses and sub network addresses of physical hosts where event services are executed.

The event registration unit 310 registers information regarding individual identifiers of applications provided by an individual management and container service, and information regarding events about which the applications are concerned, in an event database 350. The event transfer unit 320 searches for, when a certain application requests information about an event, information regarding the corresponding event from the event database 350, and transfers the information to the application.

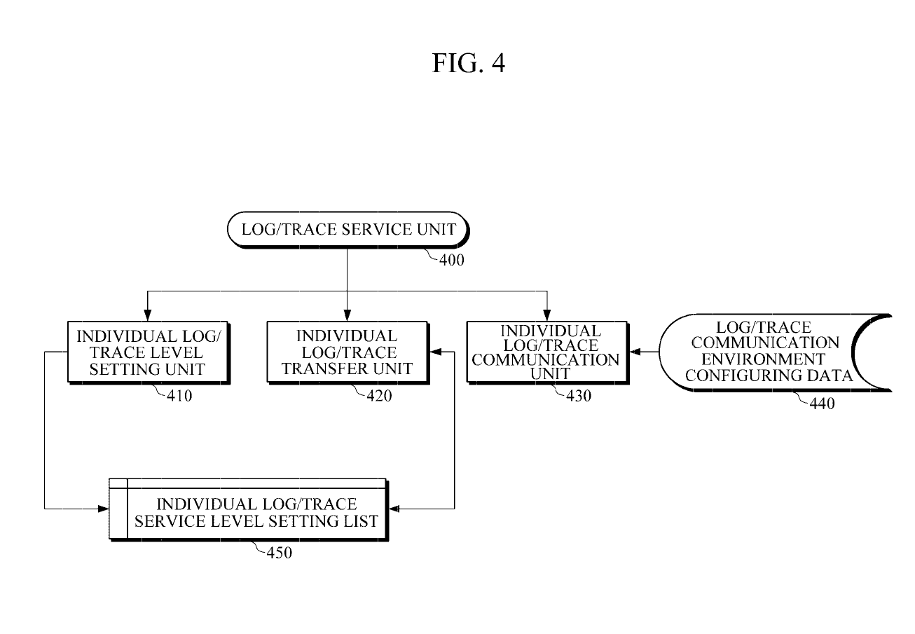

FIG. 4 is a diagram illustrating an example of a Log/Trace service unit 400.

As illustrated in FIG. 4, the Log/Trace service unit 400 includes an individual Log/Trace level setting unit 410, an individual Log/Trace transfer unit 420 and an individual Log/Trace communication unit 430. According to an example, the Log/Trace service unit 400 is a service which is used when all applications executed on a software platform write history information needed for operators or write functional verification history information needed for developers.

A communication environment of the Log/Trace communication unit 430 is established using Log/Trace communication environment configuring data 440. According to an example, the Log/Trace communication environment configuring data 440 includes the names and IP addresses of physical hosts where log services are executed. The individual Lou/Trace level setting unit 410 may set Log/Trace levels for application individuals based on information regarding the individual identifiers and Log/Trace levels of the applications. The Log/Trace level information may be at least one mode of a non-set mode, a normal mode and a detail mode.

The individual Log/Trace transfer unit 420 writes, when receiving a request from an application, information regarding the individual identifier of the application, history information needed to operators and a functional verification history needed for development, in a log service server, according to the Log/Trace level of the application.

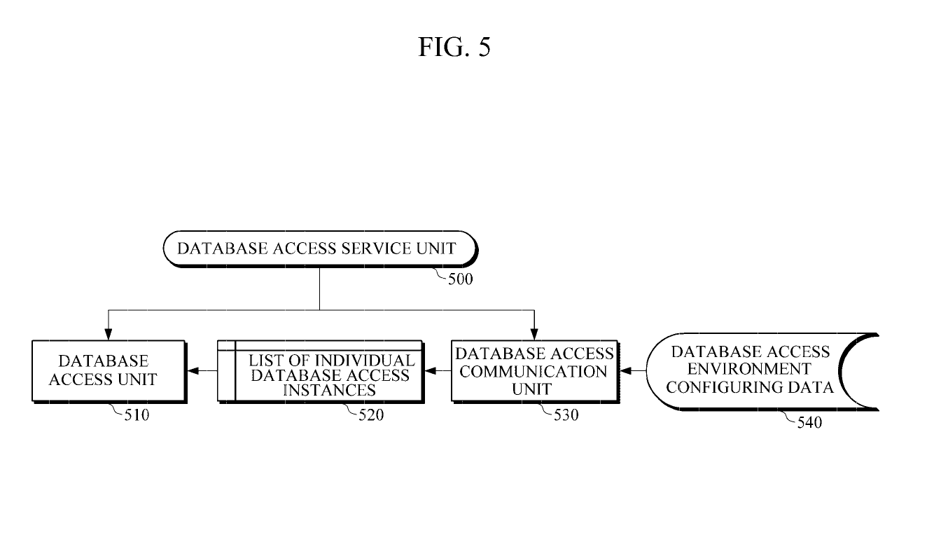

FIG. 5 is a diagram illustrating an example of a database access service unit 500.

As illustrated in FIG. 5, the database access service unit 500 includes a database access unit 510 and a database access communication unit 530.

An environment of the database access communication unit 530 is established using database access environment configuring data 540. According to an example, instances for accessing a database connected to a database server for each individual are created based on the database access environment configuring data 540 and a list 520 of the individual database access instances is established. The database access environment configuring data 540 includes informant regarding the names and IP addresses of physical hosts where a database server is executed.

The database access unit 510 can identify an individual database access instance assigned to an application from the list 520 of individual database access instances, in response to a request from the application. Accordingly, the application may share a database with the database service server using the individual database access instance assigned thereto. The database sharing may be carried out using a database query.

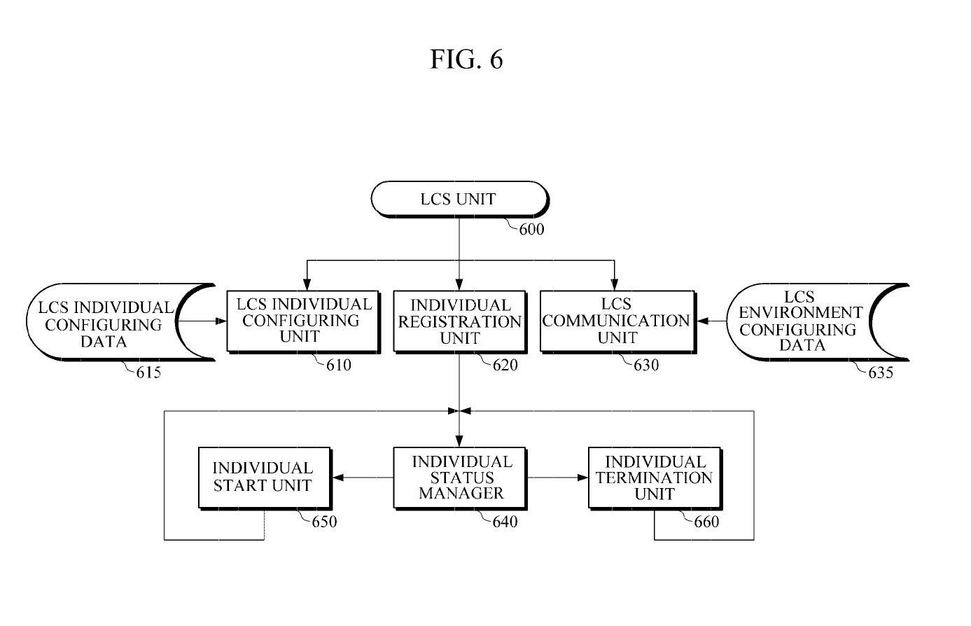

FIG. 6 is a diagram illustrating an example of a Life Cycle Service (LCS) unit 600.

As illustrated in FIG. 6, the LCS unit 600 includes a LCS individual configuring unit 610, an individual registration unit 620, a LCS communication unit 630, an individual status manager 640, an individual start unit 650 and an individual termination unit 660.

An environment of the LCS communication unit 630 is established using LCS environment configuring data 635. The LCS environment configuring data 635 includes the names and IP addresses of physical hosts where a LCS server is executed.

An environment of the LCS individual configuring unit 610 is established using LCS individual configuring data 615. Accordion to an example, the LCS individual configuring data 615 is configured in the form of a list including application information for individuals to be managed by an LCS server and attribute information for each application.

Applications may register their own individual identifiers according to a deployment through the individual registration unit 620. In other words, the individual registration unit 620 registers individual identifiers for applications. The individual status manager 640 allows the individual start unit 650 to start a service for the individual identifiers registered by the individual registration unit 620. Also, the individual status manager 640 allows the individual termination unit 660 to perform individual termination. Starting a service by the individual start unit 650 is for applications to execute their own business logics. The individual termination unit 660 makes the application individuals terminate the business logics which they have been executing.

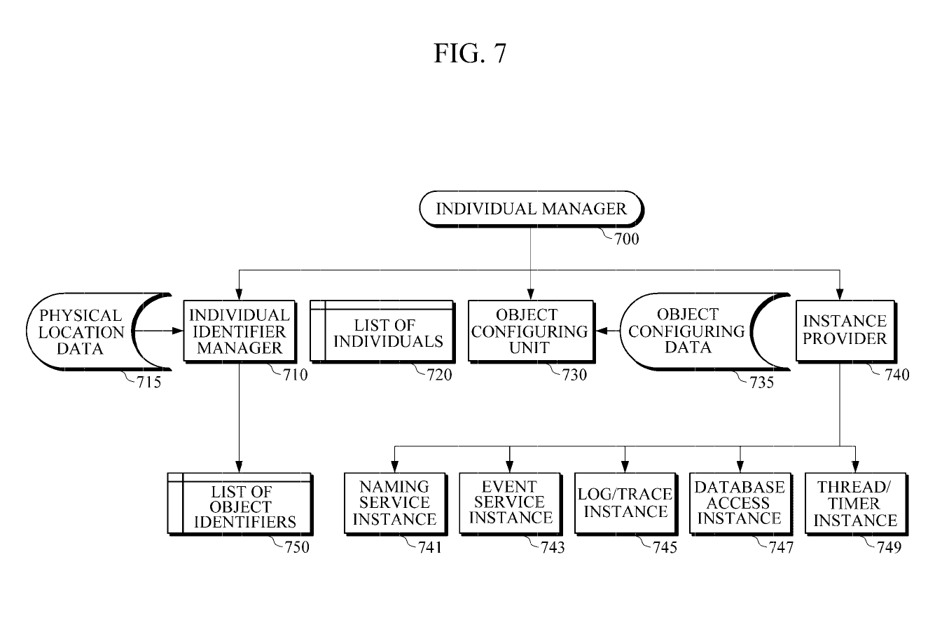

FIG. 7 is a diagram illustrating an example of an individual identifier management unit 700.

As illustrated in FIG. 7, the individual identifier management unit 700 includes an individual identifier manager 710, an object configuring unit 730 and an instance provider 740.

The instance provider 740 creates and maintains a naming service instance 741, an event service instance 743, a Log/Trace instance 745, a database access instance 747 and a Thread/Timer instance 749, to which main services on a software platform, required when applications are executed, are instantized for each object. Then, the instance provider 740 provides, when receiving a request for the instances from a certain application, the requested instances to the application.

The object configuration unit 730 creates a list of application objects 720 based on object configuring data 735. The individual identifier manager 710 creates object identifiers based on the object list 720 and physical location data for the applications depending on deployment, and stores the object identifiers in the form of a list of object identifiers 750.

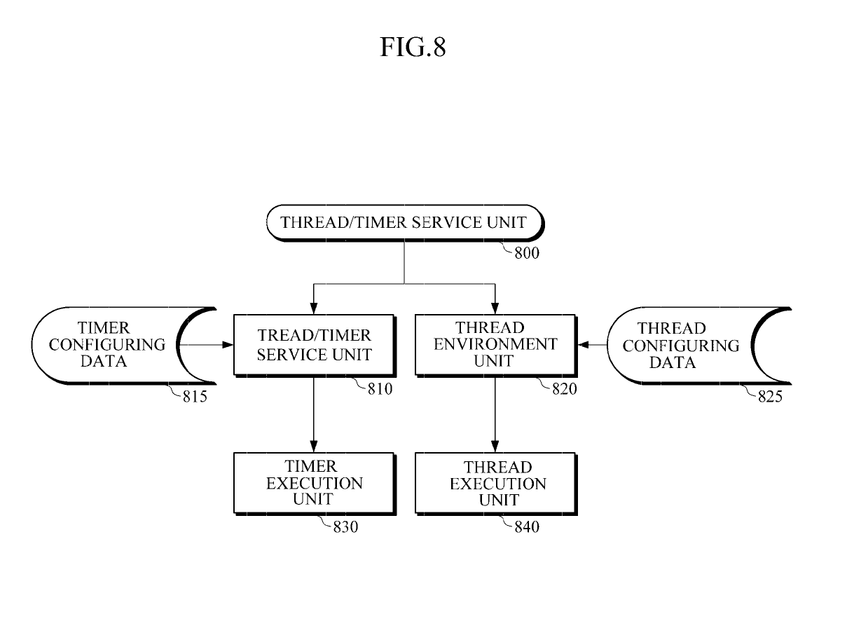

FIG. 8 is a diagram illustrating an example of a Thread/timer service unit 800.

As illustrated in FIG. 8, the Thread/timer service unit 800 includes a timer environment unit 810, a Thread environment unit 820, a timer execution unit 830 and a Thread execution unit 840.

The timer environment unit 810 is established using application-based timer configuring data 815. The application-based timer configuring data 815 includes the smallest value among multiples of tick values of timers used by applications. The timer execution unit 830 operates when a LCS server executes an individual start service for an application. The Thread environment unit 820 is established using application-based thread configuring data 825. The application-based thread configuring data 825 includes a list of Threads that are used by applications. The Thread execution unit 840 operates when a LCS server executes an individual start service for an application.

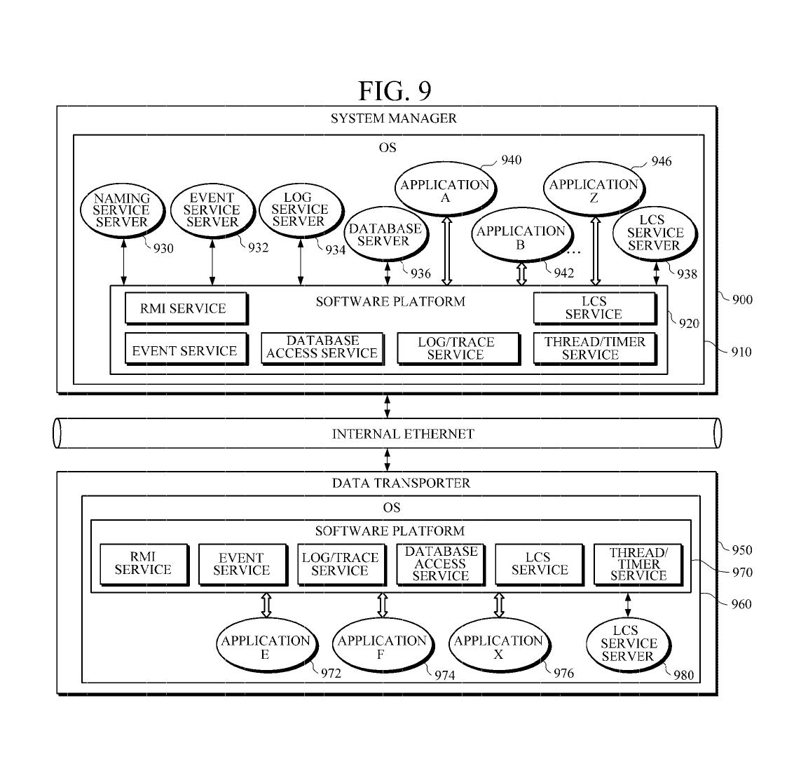

FIG. 9 is a diagram illustrating an example of a packet-optical transport system.

FIG. 9 shows deployment of system software depending on physical locations in a packet-optical transport system based on a software platform. The packet-optical transport system, which has a shelf or chassis-based physical structure, includes a system manager 900 for controlling the whole operation of the packet-optical transport system and a data transporter 950 for controlling transferring of user data in the packet-optical transport system.

According to an example, the system manager 900 may be a system management card.

System software applications, which are executed in the system manager 900, are in charge of configuration management, fault management, performance management and protocol stack management of the system, corresponding to management and control planes.

According to an example, the data transporter 950 may be a line card or a fabric card. System software applications, which are executed in the data transporter 950, are in charge of data path management for transferring user data, card-level fault management and performance management.

Software platforms 920 and 969 are placed on OS 910 and 960 of the system manager 900 and data transporter 950. System-level system plane service server processes, that is, a naming service server 930, an event service server 932, a log service server 934 and a database server 936 are executed in the system manager 900.

LCS service servers 938 and 980, which are card-level system plane servicer server processes, are executed in all cards, that is, in the system manager 900 and data transporter 950. The system-level system plane service server processes and card-level system plane service server processes are automatically executed when the packet-optical transport system boots up. Applications which are executed on software platforms 920 and 970 of the system manager 900 and the data transporter 950 are executed or terminated by the LCS service servers 938 and 980 that are executed at a physical location where the applications are executed, that is, at the system manager 900 or the data transporter 950.

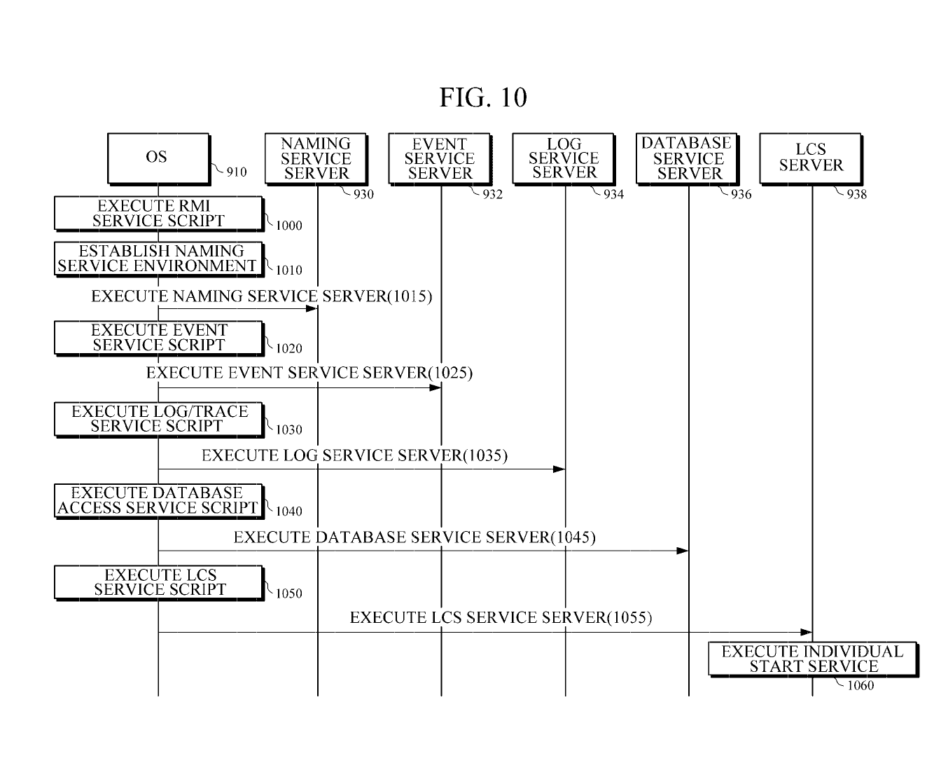

FIG. 10 is a flowchart illustrating an example of a method of initializing a server process in a system plane software platform on the system manager 900.

As illustrated in FIG. 10, when the OS 910 of the system manager 900 boots up, the OS 910 sequentially executes a RMI service script, an event service script, a Log/Trace service script, is a database access service script and a LCS service script.

First, a RMI service script for performing a RMI service is executed (operation 1000). While the RMI script is executed, a CORBA-based communication environment is established using CORBA-based communication environment configuring data. Also, a naming server service environment is established using CORBA naming service environment configuration data (operation 1010). Then, the naming service server 930 is executed (operation 1015).

Then, an event service script for performing an event service is executed (operation 1020). While the event service script is executed, an event communication service environment is established using event communication environment configuring data. Then, the event service server 932 is executed (operation 1025).

Then, a Log/Trace service script for performing a Log/Trace service is executed (operation 1030). While the Log/Trace service script is executed, a Log/Trace communication service environment is established using Log/Trace communication environment configuring data. Then, the log service server 934 is executed (operation 1035).

Then, a database access service script for performing a database access service is executed (operation 1040). While the database access service script is executed, a database access communication service environment is established using database access environment configuring data. Then, the database service server 936 is executed (operation 1045).

Then, a LCS service script for performing a LCS service is executed (operation 1050). While the LCS service script is executed, a LCS communication service environment is established using LCS environment configuring data. Then, the LCS service server 938 is executed (operation 1055). The LCS service server 938 establishes a LCS individual configuring service environment according to disposition using LCS individual configuring data based on disposition. Then, an individual start service for individuals registered through an is individual registration service is executed (operation 1060).

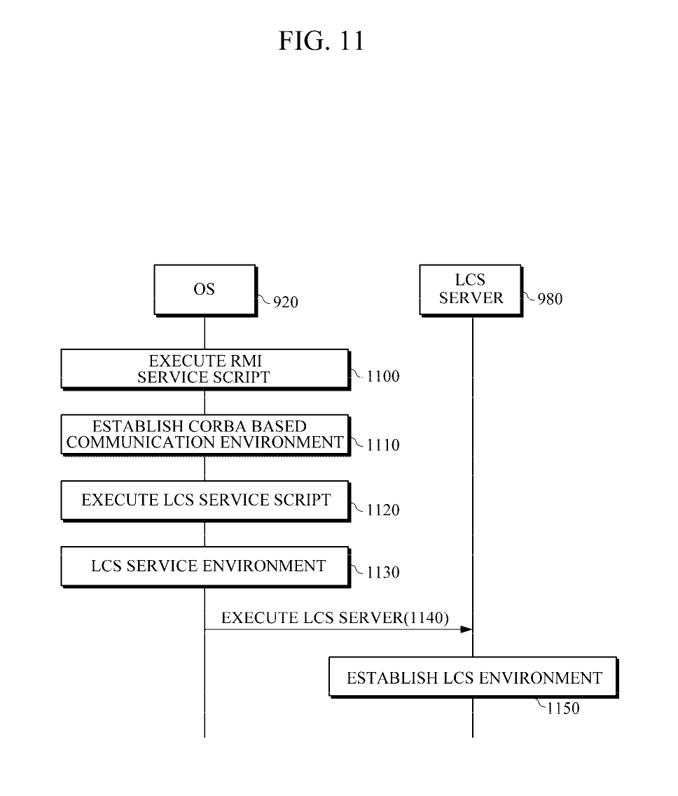

FIG. 11 is a flowchart illustrating an example of a method of initializing, on the data transporter 950, (OK?) a server process in a system plane software platform.

As illustrated in FIG. 11, an OS 920 of the data transporter 950 executes, when it boots up, an RMI script for performing an RMI service (operation 1100). While the RMI service script is executed, a CORBA-based communication service environment is established using CORBA communication environment configuring data (operation 1110). Then, a LCS service script for performing a LCS service is automatically executed (operation 1120). While the LCS service script is executed, a LCS communication service environment is established using LCS environment configuring data (operation 1130). Then, the LCS service server 980 is executed (operation 1140).

The LCS service server 980 established a LCS individual configuring service environment according to deployment using LCS individual configuring data according to disposition. Then, an individual start service for individuals registered through an individual registration service is executed (operation 1150).

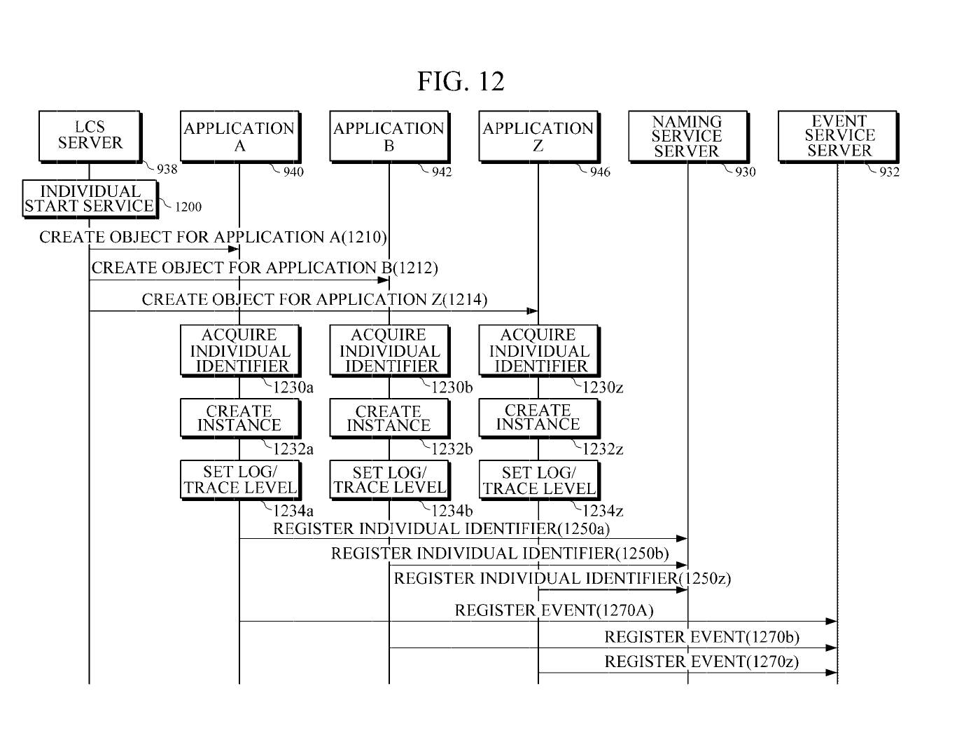

FIG. 12 is a flowchart illustrating an example of a method of initializing a container environment that is used by an application on the system manager 900.

As illustrated in FIG. 12, the LCS service server 938 establishes a LCS individual configuration service environment according to deployment using LCS individual configuring data based on disposition. At this time, an individual start service for individuals registered through an individual registration service is executed. As a result, objects for application A, application B and application Z are created (operations 1210, 1212 and 1214). The application A 940 acquires its individual identifier using an individual identifier configuring service (operation 1210). Then, the application A 940 creates a naming service instance, an event service instance, a Log/Trace service instance, a database access service instance and Thread and Timer service instances using a container environment service (operation 1232a). Also, the application A 940 sets a Lou/Trace level using an individual Log/Trace level setting service (operation 1234a). Then, the application A 940 registers its individual identifier in the naming service server 930 using a naming registration service (operation 1250a). Thereafter, the application A 940 registers an event to be used by itself in the event service server 932 using an event registration unit (operation 1270a).

Meanwhile, the application B 942 acquires its individual identifier using an individual identifier configuring unit (operation 1230b). Then, the application B 942 creates a naming service instance, an event service instance, a Log/Trace service instance, a database access service instance and Tread and Timer service instances using a container environment unit (operation 1232b). Also, the application B 942 sets a Log/Trace level using an individual Log/Trace level setting unit (operation 1234b). Then, the application B 942 registers its individual identifier in the naming service server 930 using a naming registration unit (operation 1250b). Thereafter, the application B 942 registers an event to be used by itself in the event service server 932 using an event registration unit (operation 1270b).

Likewise, the application Z 946 acquires its individual identifier using the individual identifier configuring unit (operation 1230z). Then, the application Z 946 creates a naming service instance, an event service instance, a Log/Trace service instance, a database access service instance and Thread and Timer service instances using the container environment unit (operation 1232z). Also, the application Z 946 sets a Lou/Trace level using the individual Lou/Trace level setting unit (operation 1234z). Then, the application Z 946 registers its individual identifier in the naming service server 930 using the naming registration unit (operation 1250z). Thereafter, the application Z 946 registers an event to be used by itself in the event service server 932 using the event registration unit (operation 1270z).

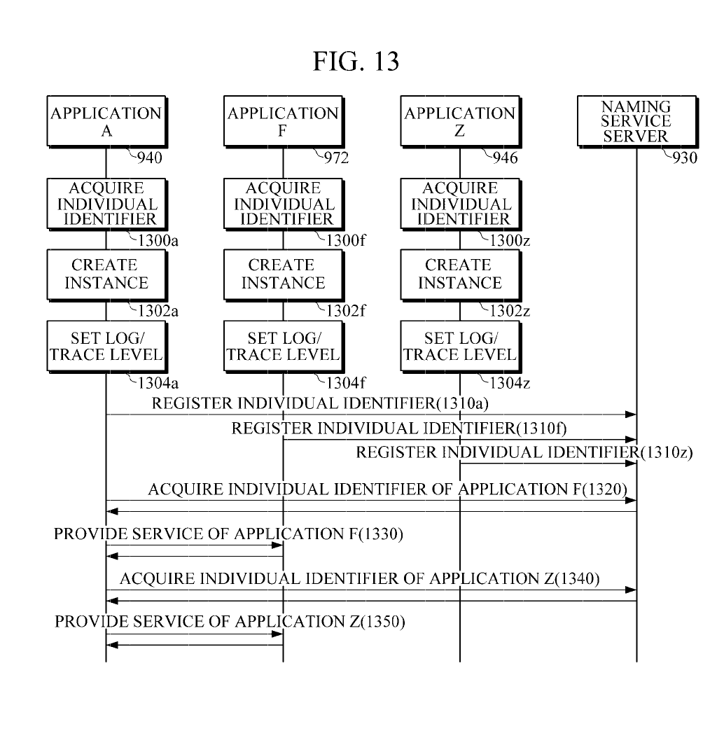

FIG. 13 is a flowchart illustrating an example of a method in which applications on a system manager and a data transporter use a naming service.

As illustrated in FIG. 13, an application A 940 which is executed by a LCS service server of the system manager acquires its individual identifier using an individual identifier configuring unit (operation 1300a). Then, the application A 940 creates a naming service instance, an event service instance, a Log/Trace service instance, a database access service instance and Thread and Timer service instances using a container environment unit (1302a). Successively, the application A 940 sets a Log/Trace level using an individual Log/Trace level setting unit (operation 1304a). Then, the application A 940 registers its own individual identifier in a naming service server 930 using a naming registration unit (operation 1310a).

Meanwhile, an application F 972 which is executed by a LCS service server of the data transporter acquires its individual identifier using the individual identifier configuring unit (operation 1300f). Then, the application F 972 creates a naming service instance, an event service instance, a Log/Trace service instance, a database access service instance and Thread and Timer service instances using the container environment unit (13020. Successively, the application F 972 sets a Lou/Trace level using the individual Log/Trace level setting unit (operation 13040. Then, the application F 972 registers its own individual identifier in the naming service server 930 using the naming registration unit (operation 1310f).

Likewise, an application Z 946 which is executed by the LCS service server of the system manager acquires its individual identifier using the individual identifier configuring unit (operation 1300z). Then, the application Z 946 creates a naming service instance, an event service instance, a Log/Trace service instance, a database access service instance and Thread and Timer service instances using the container environment unit (1302z). Successively, the application Z 946 sets a Log/Trace level using the individual Log/Trace level setting unit (operation 1304z). Then, the application Z 946 registers its own individual identifier in the naming service server 930 using the naming registration unit (operation 1310z).

According to an example, there is provided a distributed computing environment where the application A 940 and the application Z 946 are performed in the system manger and the application F 972 is executed in the data transporter. In order for the application A 940 to use a service provided by the application F 972, the application A 940 has to identify the location of an object access interface of the application F 972. Accordingly, the application A 940 acquires the location of the object access interface of the application F 972 from the naming service server 930 using a naming searching unit (operation 1320).

Accordingly, the application A 940 can access the object access interface of the application F 972 using information regarding the location of the object access interface of the application F 972 and receive the service provided by the application F 972 (operation 1330). Also, in order for the application A 940 to use a service provided by the application Z 946, the application A 940 has to identify the location of an object access interface of the application Z 946. Accordingly, the application A 940 acquires the location of the object access interface of the application Z 946 from the naming service server 930 using the naming searching unit (operation 1340). Thereafter, the application A 940 can access the object access interface of the application Z 946 using information regarding the location of the object access interface of the application Z 946 and receive the service provided by the application Z 946 (operation 1350).

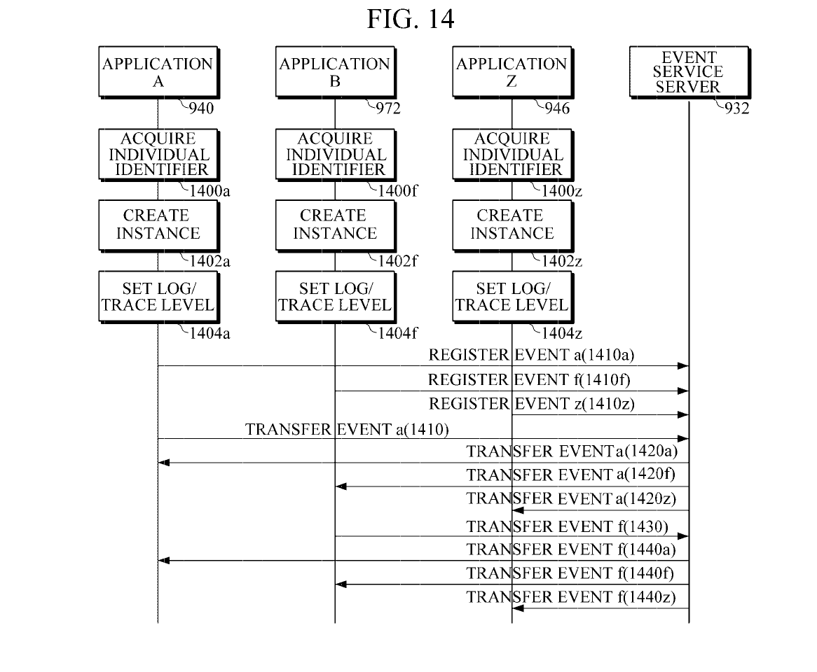

FIG. 14 is a flowchart illustrating an example of a method in which applications on a system manager and a data transporter use an event service.

As illustrated in FIG. 14, an application A 940 which is executed by a LCS service server of the system manager acquires its individual identifier using an individual identifier configuring unit (operation 1400a). Then, the application A 940 creates a naming service instance, an event service instance, a Log/Trace service instance, a database access service instance and Thread and timer service instances using a container environment unit (operation 1402a). Successively, the application A 940 sets a Log/Trace level using an individual Log/Trace level setting unit (operation 1404a). Then, the application A 940 registers an event to be used by itself in an event service server 932 using an event registration unit (operation 1410a).

Meanwhile, an application F 972 which is executed by a LCS service server of the data transporter acquires its individual identifier using the individual identifier configuring unit (operation 14000. Then, the application F 972 creates a naming service instance, an event service instance, a Log/Trace service instance, a database access service instance and Thread and Timer service instances using the container environment unit (14020. Successively, the application F 972 sets a Log/Trace level using the individual Log/Trace level setting unit (operation 14040. Then, the application F 972 registers an event f to be used by itself in the event service server 932 using the event registration unit (operation 14100.

Likewise, an application Z 946 which is executed by the LCS service server of the system manager acquires its individual identifier using the individual identifier configuring unit (operation 1400z). Then, the application Z 946 creates a naming service instance, an event service instance, a Log/Trace service instance, a database access service instance and Thread and Timer service instances using the container environment unit (1402z). Successively, the application Z 946 sets a Log/Trace level using the individual Log/Trace level setting unit (operation 1404z). Then, the application Z 946 registers an event z to be used by itself in the event service server 932 using the event registration unit (operation 1410z).

According to an example, there is provided a distributed computing environment where the application A 940 and the application Z 946 are performed in the system manger and the application F 972 is executed in the data transporter.

In order for the application A 940 to transfer an event to the applications F 972 and Z 946, the application A transfers the event a to the event service server 932 using an event transfer unit (operation 1410). Then, the event service server 932 transfers the event to the registered application A 940, the application F 972 and the application Z 946 (operations 1420a, 1420f and 1420z).

Thereafter, in order for the application F 972 to transfer an event f to the applications A 940 and Z 946, the application F 972 transfer the event f to the event service server 932 using the event transfer unit (operation 1430). Thereafter, the event service server 932 transfers the event f to the registered application A 940, the application F 972 and the application Z 946 (operations 1440a, 1440f and 1440z).

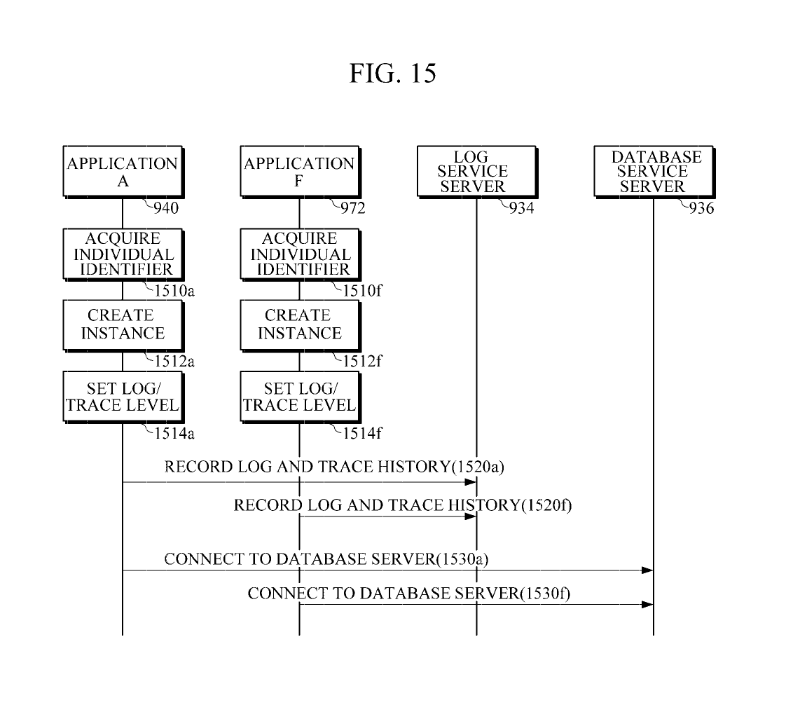

FIG. 15 is a flowchart illustrating an example of a method in which applications on a system manager and a data transporter use a log/trace service and a database access service.

First, an application A 940 which is executed by a LCS service server of the system manager acquires its individual identifier using an individual identifier configuring unit (operation 1510a). Then, the application A 940 creates a naming service instance, an event service instance, a Log/Trace service instance, a database access service instance and Thread and Timer service instances using a container environment unit (1512a). Successively, the application A 940 sets a Log/Trace level using an individual Log/Trace level setting unit (operation 1514a).

Meanwhile, an application F 972 which is executed by a LCS service server of the data transporter acquires its individual identifier using the individual identifier configuring unit (operation 1510f). Then, the application F 972 creates a naming service instance, an event service instance, a Log/Trace service instance, a database access service instance and Thread and Timer service instances using the container environment unit (15120. Successively, the application F 972 sets a Lou/Trace level using the individual Log/Trace level setting unit (operation 1514f).

There is provided a distributed computing environment where the application A 940 is executed in the system manager and the application F 972 is executed in the data transporter.

The application A 940 transfers a log and trace history to a log service server 934 using a Log/Trace transfer unit. Then, the log service server 934 records the received log and trace history in the form of a file (operation 1520a). Likewise, the application F 972 transfers a log and trace history to the log service server 934 using the Log/Trace transfer unit and the log service server 934 records the received log and trace history (operation 15200.

Meanwhile, the application A 940 is connected to a database service server 938 using a database access unit (operation 1530a). The application F 972 is also connected to the database service server using the database access unit (operation 15300.

The method of managing applications as individuals, as described above, may be recorded as a computer program. The program may be stored in a computer readable media and read and executed by a computer. The computer readable media may be a magnetic tape, optical media or the like.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A software platform comprising:
an individual identifier manager to assign an individual identifier to each object of an application that is executed in a distributed computing environment and to manage the individual identifier; and
an instance provider to create an instance for a service object in response to a request from the application and to provide the instance to the application.

2. The software platform of claim 1, further comprising:
a naming registration unit to match access interface information for an instantized object of the application to information regarding the individual identifier of the application, the individual identifier assigned by the individual identifier manager, and to store the result of the matching in a naming database; and
is a naming searching unit to search for the access interface information corresponding to the individual identifier of the application, based on the result of the matching stored in the naming database.

3. The software platform of claim 1, further comprising a communication supporting unit to support a communication environment between the object of the application and the service object.

4. The software platform of claim 1, further comprising:
an event registration unit to store specific event information with the individual identifier information of the application in an event database, in response to an event registration request from the application; and
an event transfer unit to transfer, when receiving a request requesting an event stored in the event database from the application, information about the event to the application.

5. The software platform of claim 1, further comprising a Log/Trace service unit to record the individual identifier information of the application, history information which is an execution result of the application, and a functional verification history needed for development, in response to a request from the application.

6. The software platform of claim 5, wherein the Lou/Trace service unit records the history information and the functional verification history according to a predetermined recording period level.

7. The software platform of claim 1, further comprising a database access service unit to create a database access instance to establish a list of individual database access instances, to identify an individual database access instance assigned to an application from the list of individual database access instances in response to a request from the application, and to provide the individual database access instance to the application.

8. The software platform of claim 1, further comprising:
an individual registration unit to acquire and store information regarding an individual identifier of an application in response to a request from the application; and
an individual status manager to provide an individual start service or an individual termination service for individual applications stored in the individual registration unit.

9. The software platform of claim 1, further comprising an object configuring unit to create a list of application objects based on object configuring data,
wherein the object identifier manager creates individual identifiers based on the list of application objects and physical location data of the applications depending on disposition, and stores the individual identifiers in the form of a list of individual identifiers.

10. The software platform of claim 8, further comprising a timer execution unit to start a count when the individual status manager executes an individual start service of an application.

11. A method of managing applications as individuals in a software platform, comprising:
is creating an instance for a service object in response to a request from an application that is executed in a distributed computing environment; and
providing the instance for the service object to the application.

12. The method of claim 11, further comprising:
creating a list of objects of applications that are executed;
creating an individual identifier for each of the applications based on the list of the objects of the applications and physical location data of the applications; and
storing the individual identifiers in the form of a list of individual identifiers.

13. The method of claim 12, further comprising:
matching access interface information for an instantized object of the application to information regarding the individual identifier of the application and storing the result of the matching in a naming database; and
searching for the access interface information corresponding to the individual identifier of the application, based on the result of the matching stored in the naming database, in response to a request from the application.

14. The method of claim 12, further comprising:
storing specific event information with the individual identifier information of the application in an event database, in response to an event registration request from the application; and
transferring, when receiving a request requesting information regarding an event stored in the event database from the application, the information to the application.

15. The method of claim 12, further comprising: recording the individual identifier information of the application, history information which is an execution result of the application, and a functional verification history needed for development, in response to a request from the application.

16. The method of claim 12, further comprising:
creating individual database access instances and establishing a list of the individual database access instances; and
identifying an individual database access instance assigned to an application from the list of the individual database access instances, in response to a request from the application, and providing the individual database access instance to the application.

17. The method of claim 12, further comprising:
acquiring and storing information regarding an individual identifier of an application; and
providing an individual start service or an individual termination service for stored application individuals in response to a request from the application.

18. The method of claim 17, further comprising starting a timer count when the individual start service is provided.
